(19) United States
(12) Patent Application Publication
(10) Pub. No.: US 2020/0410991 A1
(43) Pub. Date: Dec. 31, 2020

(54) SYSTEM AND METHOD FOR PREDICTIVE SPEECH TO TEXT

(71) Applicant: Nuance Communications, Inc., Burlington, MA (US)

(72) Inventors: Uwe Helmut JOST, Groton, MA (US); Bridges SMITH, Burlington, MA (US)

(21) Appl. No.: 16/588,883

(22) Filed: Sep. 30, 2019

Related U.S. Application Data
(60) Provisional application No. 62/868,500, filed on Jun. 28, 2019.

(51) Int. Cl. G10L 15/197; G10L 15/22; G06F 3/01

(52) U.S. Cl. CPC G10L 15/197; G10L 2015/223; G06F 3/017; G10L 15/22

(57) ABSTRACT

A method, computer program product, and computer system for receiving, by a computing device, speech from a user. A next word following a current word in the speech from the user may be predicted. The next word that is predicted following the current word recognized in the speech from the user may be presented to the user in real time. Feedback from the user may be received whether to one of accept and reject the next word that is predicted. The speech from the user may be processed to convert the speech to text, wherein the text may include the next word when the feedback from the user is to accept the next word that is predicted and wherein the text may exclude the next word when the feedback from the user is to reject the next word that is predicted.

### RELATED APPLICATION(S)

This application claims the benefit of U.S. Provisional Application No. 62/868,500, filed on 28 Jun. 2019, the contents of which are all incorporated by reference.

### BACKGROUND

Generally, automatic speech recognition (ASR) systems, particularly speech to text, may not perform as well when the speaker uses unusual (e.g., rare) formulations, hesitates, stumbles, or otherwise does not speak clearly. Similarly, any further processing stages using the ASR output may be likely to succeed when receiving an expected input, while being likely to fail with an unexpected input.

### BRIEF SUMMARY OF DISCLOSURE

In one example implementation, a method, performed by one or more computing devices, may include but is not limited to receiving, by a computing device, speech from a user. A next word following a current word recognized in the speech from the user may be predicted. The next word that is predicted following the current word in the speech from the user may be presented to the user in real time. Feedback from the user may be received whether to one of accept and reject the next word that is predicted. The speech from the user may be processed to convert the speech to text, wherein the text may include the next word when the feedback from the user is to accept the next word that is predicted and wherein the text may exclude the next word when the feedback from the user is to reject the next word that is predicted.

One or more of the following example features may be included. Presenting to the user in real time the next word that is predicted following the current word in the speech may include displaying the next word differently than another word in the speech that is not predicted. Presenting to the user in real time the next word that is predicted following the current word in the speech may include playing audio of the next word. Receiving feedback from the user may include receiving one of an audio input and a visual input from the user. The audio input may include one of speech from the user pronouncing the next word, clapping, and snapping from the user. The visual input may include a physical gesture by the user captured by a device. Receiving feedback from the user may include receiving a physical selection from the user of the next word on a device.

In another example implementation, a computing system may include one or more processors and one or more memories configured to perform operations that may include but are not limited to receiving speech from a user. A next word following a current word recognized in the speech from the user may be predicted. The next word that is predicted following the current word in the speech from the user may be presented to the user in real time. Feedback from the user may be received whether to one of accept and reject the next word that is predicted. The speech from the user may be processed to convert the speech to text, wherein the text may include the next word when the feedback from the user is to accept the next word that is predicted and wherein the text may exclude the next word when the feedback from the user is to reject the next word that is predicted.

One or more of the following example features may be included. Presenting to the user in real time the next word that is predicted following the current word in the speech may include displaying the next word differently than another word in the speech that is not predicted. Presenting to the user in real time the next word that is predicted following the current word in the speech may include playing audio of the next word. Receiving feedback from the user may include receiving one of an audio input and a visual input from the user. The audio input may include one of speech from the user pronouncing the next word, clapping, and snapping from the user. The visual input may include a physical gesture by the user captured by a device. Receiving feedback from the user may include receiving a physical selection from the user of the next word on a device.

In another example implementation, a computer program product may reside on a computer readable storage medium having a plurality of instructions stored thereon which, when executed across one or more processors, may cause at least a portion of the one or more processors to perform operations that may include but are not limited to receiving speech from a user. A next word following a current word recognized in the speech from the user may be predicted. The next word that is predicted following the current word in the speech from the user may be presented to the user in real time. Feedback from the user may be received whether to one of accept and reject the next word that is predicted. The speech from the user may be processed to convert the speech to text, wherein the text may include the next word when the feedback from the user is to accept the next word that is predicted and wherein the text may exclude the next word when the feedback from the user is to reject the next word that is predicted.

One or more of the following example features may be included. Presenting to the user in real time the next word that is predicted following the current word in the speech may include displaying the next word differently than another word in the speech that is not predicted. Presenting to the user in real time the next word that is predicted following the current word in the speech may include playing audio of the next word. Receiving feedback from the user may include receiving one of an audio input and a visual input from the user. The audio input may include one of speech from the user pronouncing the next word, clapping, and snapping from the user. The visual input may include a physical gesture by the user captured by a device. Receiving feedback from the user may include receiving a physical selection from the user of the next word on a device.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a prediction process coupled to an example distributed computing network according to one or more example implementations of the disclosure;

FIG. 2 is an example diagrammatic view of a computer and client electronic device of FIG. 1 according to one or more example implementations of the disclosure;

FIG. 3 is an example flowchart of a prediction process according to one or more example implementations of the disclosure;

FIG. 4 is an example diagrammatic view of a user interface used by a prediction process according to one or more example implementations of the disclosure;

FIG. 5 is an example diagrammatic view of a user interface used by a prediction process according to one or more example implementations of the disclosure;

FIG. 6 is an example diagrammatic view of a user interface used by a prediction process according to one or more example implementations of the disclosure.

Like reference symbols in the various drawings may indicate like elements.

### DETAILED DESCRIPTION

System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

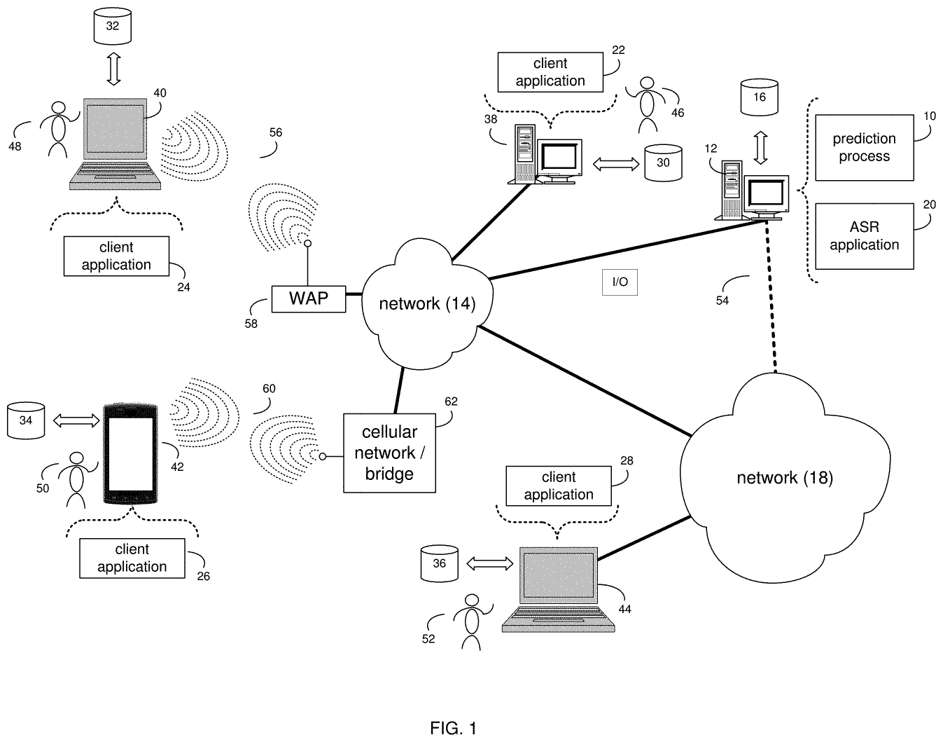

Referring now to the example implementation of FIG. 1, there is shown prediction process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a prediction process, such as prediction process 10 of FIG. 1, may receive, by a computing device, speech from a user. A next word following a current word in the speech from the user may be predicted. The next word that is predicted following the current word in the speech from the user may be presented to the user in real time. Feedback from the user may be received whether to one of accept and reject the next word that is predicted. The speech from the user may be processed to convert the speech to text, wherein the text may include the next word when the feedback from the user is to accept the next word that is predicted and wherein the text may exclude the next word when the feedback from the user is to reject the next word that is predicted.

In some implementations, the instruction sets and subroutines of prediction process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store 20, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, prediction process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute an automatic speech recognition application (e.g., automatic speech recognition application 20), examples of which may include, but are not limited to, e.g., an automatic speech recognition (ASR) application (e.g., speech recognition application 20), examples of which may include, but are not limited to, e.g., an automatic speech recognition (ASR) application (e.g., modeling, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a web conferencing application, a video conferencing application, a voice-over-IP application, a video-over-IP application, an Instant Messaging (IM)/“chat” application, a short messaging service (SMS)/multimedia messaging service (MMS) application, an email application, or other application that allows for ASR based communication. In some implementations, prediction process 10 and/or automatic speech recognition application 20 may be accessed via one or more of client applications 22, 24, 26, 28. In some implementations, prediction process 10 may be a standalone application, or may be an applet/application/script/extension that may interact with and/or be executed within automatic speech recognition application 20, a component of automatic speech recognition application 20, and/or one or more of client applications 22, 24, 26, 28. In some implementations, automatic speech recognition application 20 may be a standalone application, or may be an applet/application/script/extension that may interact with and/or be executed within prediction process 10, a component of prediction process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of prediction process 10 and/or automatic speech recognition application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, or other application that allows for ASR based communication, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone (such as those embedded within eyeglasses, smart phones, tablet computers and/or watches, etc.), and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of prediction process 10 (and vice versa). Accordingly, in some implementations, prediction process 10 may be a purely server-side application, a purely client-side application, or a hybrid server-side/client-side application that is cooperatively executed by one or more of client applications 22, 24, 26, 28 and/or prediction process 10.

In some implementations, one or more of client applications 22, 24, 26, 28 may be configured to effectuate some or all of the functionality of automatic speech recognition application 20 (and vice versa). Accordingly, in some implementations, automatic speech recognition application 20 may be a purely server-side application, a purely client-side application, or a hybrid server-side/client-side application that is cooperatively executed by one or more of client applications 22, 24, 26, 28 and/or automatic speech recognition application 20. As one or more of client applications 22, 24, 26, 28, prediction process 10, and automatic speech recognition application 20, taken singly or in any combination, may effectuate some or all of the same functionality, any description of effectuating such functionality via one or more of client applications 22, 24, 26, 28, prediction process 10, automatic speech recognition application 20, or combination thereof, and any described interaction(s) between one or more of client applications 22, 24, 26, 28, prediction process 10, automatic speech recognition application 20, or combination thereof to effectuate such functionality, should be taken as an example only and not to limit the scope of the disclosure.

In some implementations, one or more of users 46, 48, 50, 52 may access computer 12 and prediction process 10 (e.g., using one or more of client electronic devices 38, 40, 42, 44) directly through network 14 or through secondary network 18. Further, computer 12 may be connected to network 14 through secondary network 18, as illustrated with phantom link line 54. Prediction process 10 may include one or more user interfaces, such as browsers and textual or graphical user interfaces, through which users 46, 48, 50, 52 may access prediction process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14. In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests may be sent from, e.g., client applications 22, 24, 26, 28 to, e.g., computer 12 (and vice versa). Examples of I/O requests may include but are not limited to, data write requests (e.g., a request that content be written to computer 12) and data read requests (e.g., a request that content be read from computer 12).

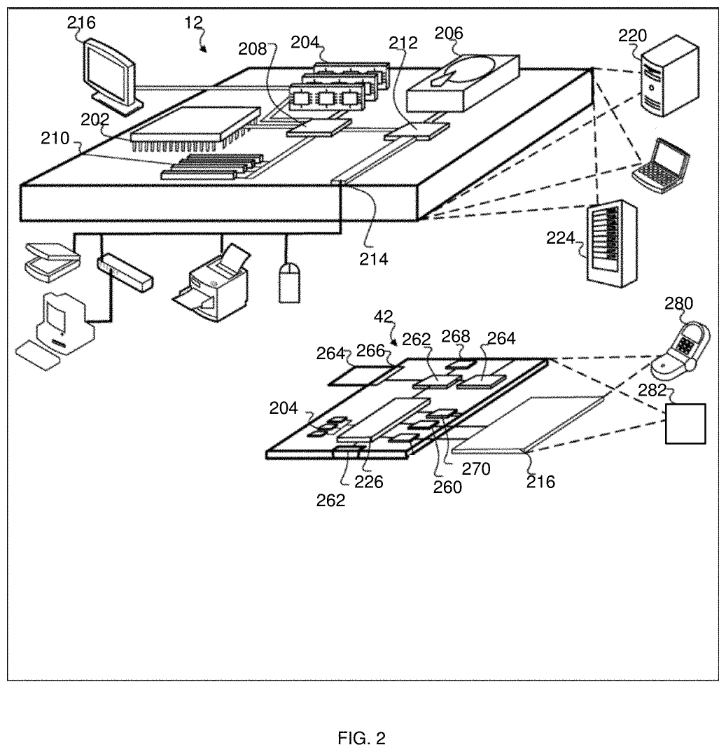

Referring also to the example implementation of FIG. 2, there is shown a diagrammatic view of computer 12 and client electronic device 42. While client electronic device 42 and computer 12 are shown in this figure, this is for example purposes only and is not intended to be a limitation of this disclosure, as other configurations are possible. Additionally, any computing device capable of executing, in whole or in part, prediction process 10 may be substituted for client electronic device 42 and computer 12 (in whole or in part) within FIG. 2, examples of which may include but are not limited to one or more of client electronic devices 38, 40, and 44. Client electronic device 42 and/or computer 12 may also include other devices, such as televisions with one or more processors embedded therein or attached thereto as well as any of the microphones, microphone arrays, and/or speakers described herein. The components shown here, their connections and relationships, and their functions, are meant to be examples only, and are not meant to limit implementations of the disclosure described.

In some implementations, computer 12 may include processor 202, memory 204, storage device 206, a high-speed interface 208 connecting to memory 204 and high-speed expansion ports 210, and low speed interface 212 connecting to low speed bus 214 and storage device 206. Each of the components 202, 204, 206, 208, 210, and 212, may be interconnected using various busses, and may be mounted on a common motherboard or in other manners as appropriate. The processor 202 can process instructions for execution within the computer 12, including instructions stored in the memory 204 or on the storage device 206 to display graphical information for a GUI on an external input/output device, such as display 216 coupled to high speed interface 208. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

Memory 204 may store information within the computer 12. In one implementation, memory 204 may be a volatile memory unit or units. In another implementation, memory 204 may be a non-volatile memory unit or units. The memory 204 may also be another form of computer-readable medium, such as a magnetic or optical disk.

Storage device 206 may be capable of providing mass storage for computer 12. In one implementation, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204, the storage device 206, memory on processor 202, or a propagated signal.

High speed controller 208 may manage bandwidth-intensive operations for computer 12, while the low speed controller 212 may manage lower bandwidth-intensive operations. Such allocation of functions is exemplary only. In one implementation, the high-speed controller 208 may be coupled to memory 204, display 216 (e.g., through a graphics processor or accelerator), and to high-speed expansion ports 210, which may accept various expansion cards (not shown). In the implementation, low-speed controller 212 is coupled to storage device 206 and low-speed expansion port 214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computer 12 may be implemented in a number of different forms, as shown in the figure. For example, computer 12 may be implemented as a standard server 220, or multiple times in a group of such servers. It may also be implemented as part of a rack server system 224. Alternatively, components from computer 12 may be combined with other components in a mobile device (not shown), such as client electronic device 42. Each of such devices may contain one or more of computer 12, client electronic device 42, and an entire system may be made up of multiple computing devices communicating with each other.

Client electronic device 42 may include processor 226, memory 204, an input/output device such as display 216, a communication interface 262, and a transceiver 264, among other components. Client electronic device 42 may also be provided with a storage device, such as a microdrive or other device, to provide additional storage. Each of the components 226, 204, 216, 262, and 264, may be interconnected using various buses, and several of the components may be mounted on a common motherboard or in other manners as appropriate.

Processor 226 may execute instructions within client electronic device 42, including instructions stored in the memory 204. The processor may be implemented as a chipset of chips that include separate and multiple analog and digital processors. The processor may provide, for example, for coordination of the other components of client electronic device 42, such as control of user interfaces, applications run by client electronic device 42, and wireless communication by client electronic device 42.

In some embodiments, processor 226 may communicate with a user through control interface 258 and display interface 260 coupled to a display 216. The display 216 may be, for example, a TFT LCD (Thin-Film-Transistor Liquid Crystal Display) or an OLED (Organic Light Emitting Diode) display, or other appropriate display technology. The display interface 260 may comprise appropriate circuitry for driving the display 216 to present graphical and other information to a user. The control interface 258 may receive commands from a user and convert them for submission to the processor 226. In addition, an external interface 262 may be provide in communication with processor 226, so as to enable near area communication of client electronic device 42 with other devices. External interface 262 may provide, for example, for wired communication in some implementations, or for wireless communication in other implementations, and multiple interfaces may also be used.

In some embodiments, memory 204 may store information within the Client electronic device 42. The memory 204 can be implemented as one or more of a computer-readable medium or media, a volatile memory unit or units, or a non-volatile memory unit or units. Expansion memory 264 may also be provided and connected to client electronic device 42 through expansion interface 266, which may include, for example, a SIMM (Single In Line Memory Module) card interface. Such expansion memory 264 may provide extra storage space for client electronic device 42, or may also store applications or other information for client electronic device 42. Specifically, expansion memory 264 may include instructions to carry out or supplement the processes described above, and may include secure information also. Thus, for example, expansion memory 264 may be provide as a security module for client electronic device 42, and may be programmed with instructions that permit secure use of client electronic device 42. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 204, expansion memory 264, memory on processor 226, or a propagated signal that may be received, for example, over transceiver 264 or external interface 262.

Client electronic device 42 may communicate wirelessly through communication interface 262, which may include digital signal processing circuitry where necessary. Communication interface 262 may provide for communications under various modes or protocols, such as GSM voice calls, SMS, EMS, or MMS speech recognition, CDMA, TDMA, PDC, WCDMA, CDMA2000, or GPRS, among others. Such communication may occur, for example, through radio-frequency transceiver 264. In addition, short-range communication may occur, such as using a Bluetooth, WiFi, or other such transceiver (not shown). In addition, GPS (Global Positioning System) receiver module 268 may provide additional navigation and location-related wireless data to client electronic device 42, which may be used as appropriate by applications running on client electronic device 42.

Client electronic device 42 may also communicate audibly using audio codec 270, which may receive spoken information from a user and convert it to usable digital information. Audio codec 270 may likewise generate audible sound for a user, such as through a speaker, e.g., in a handset of client electronic device 42. Such sound may include sound from voice telephone calls, may include recorded sound (e.g., voice messages, music files, etc.) and may also include sound generated by applications operating on client electronic device 42.

Client electronic device 42 may be implemented in a number of different forms, as shown in the figure. For example, it may be implemented as a cellular telephone 280. It may also be implemented as part of a smartphone 282, personal digital assistant, remote control, or other similar mobile device.

As noted above, automatic speech recognition (ASR) systems, particularly speech to text, may not perform as well when the speaker uses unusual (e.g., rare) formulations, hesitates, stumbles, or otherwise does not speak clearly. Similarly, any further processing stages using the ASR output may be likely to succeed when receiving an expected input, while being likely to fail with an unexpected input. As such, the present disclosure may improve existing ASR based technology by guiding the speakers to use specific predicted words/phrases while the speaker is using ASR technology, which may help increase the likelihood of correct recognition and processing, decrease the processing power/resources required (e.g., the predicted words do not need to go through ASR processing), may reduce the speaker's effort (e.g., there is a chance that the predicted words will not have to be corrected by the speaker if accurate), and may reduce overall cost of the solution by shortening the duration of a transaction (e.g., saving costs for telephony for shortened calls, or reducing network traffic by avoiding the need to send additional speech/response). Beyond the benefit of improved ASR accuracy, by recommending text that an automated system can understand, the user may be guided to use semantically equivalent words that increase the success of the interaction, further accelerating faster time to resolution and increasing overall transaction completion.

The Prediction Process:

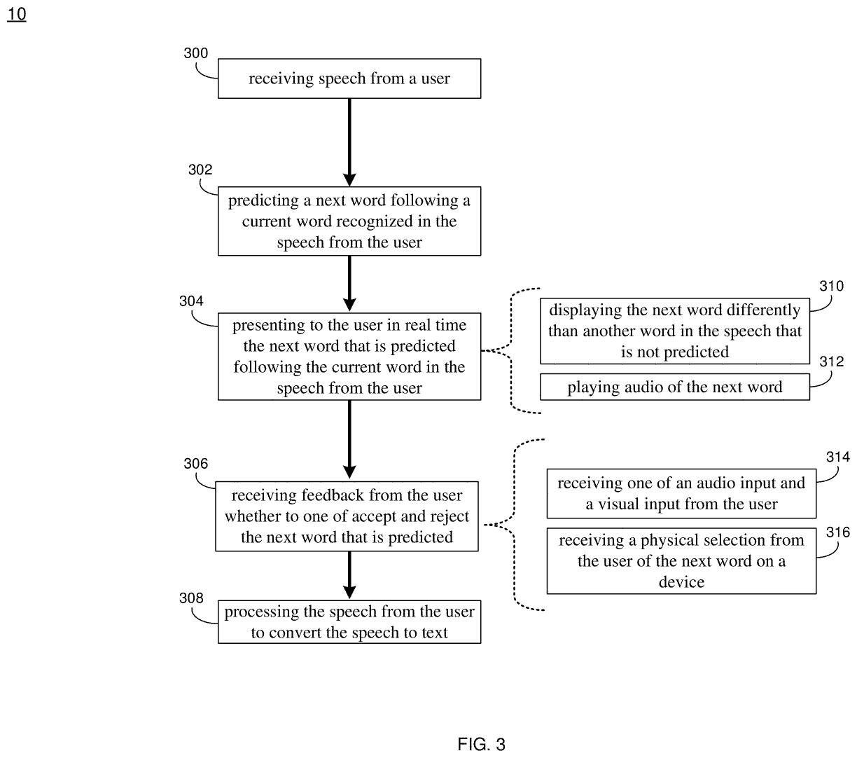

As discussed above and referring also at least to the example implementations of FIGS. 3-6, prediction process 10 may receive 300, by a computing device, speech from a user. Prediction process 10 may predict 302 a next word following a current word recognized in the speech from the user. Prediction process 10 may present 304 in real time the next word that is predicted following the current word in the speech from the user. Prediction process 10 may receive 306 feedback from the user whether to one of accept and reject the next word that is predicted. Prediction process 10 may process 308 the speech from the user to convert the speech to text, wherein the text may include the next word when the feedback from the user is to accept the next word that is predicted and wherein the text may exclude the next word when the feedback from the user is to reject the next word that is predicted.

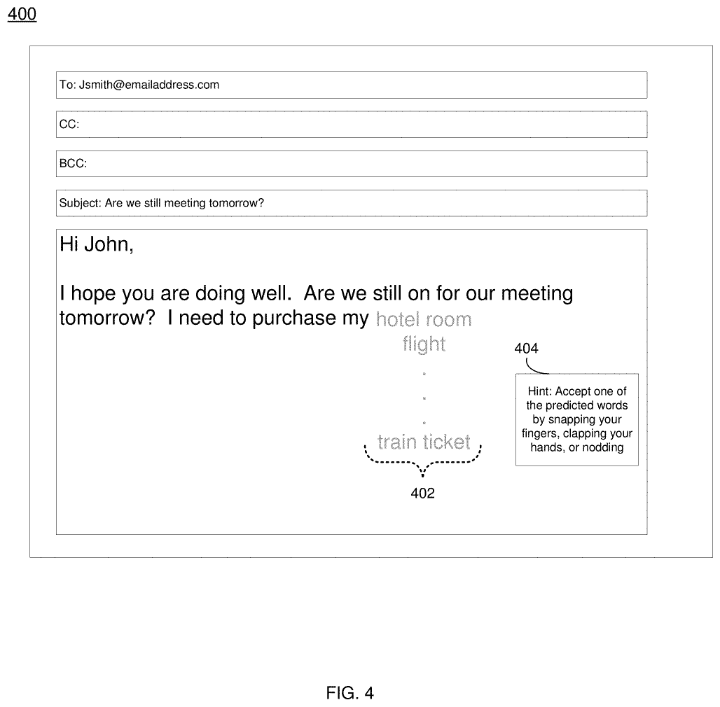

In some implementations, prediction process 10 may receive 300, by a computing device, speech from a user. For instance, assume for example purposes only that a user (e.g., user 50) is using a computing device (e.g., client electronic device 42) to draft an email. An example and non-limiting user interface (e.g., UI 400) associated with prediction process 10 is shown in the example implementation of FIG. 4. In the example, user 50 is drafting an email; however, it will be appreciated that any application capable of using ASR may be used without departing from the scope of the disclosure (e.g., text messages, instant messaging, dictation/transcription/word processing, voice commands, etc.). Assume for example purposes only that user 50 uses his speech to draft/dictate the email (e.g., via any ASR application). The speech from user 50 (e.g., Hi John, I hope you are doing well. Are we still on for our meeting tomorrow? I need to purchase my . . . ”) may be received 300 by client electronic device 42 using any audio input device (e.g., one or more microphones of client electronic device 42, a wired/wireless microphone, etc.). In the example, the speech may be converted into text (speech to text or STT) using any known STT technique, which may then be displayed in the email being drafted by prediction process 10 in substantially real time (i.e., while user 50 is speaking).

In some implementations, prediction process 10 may predict 302 a next word following a current word recognized in the speech from the user. For instance, while user 50 is still speaking, prediction process 10 may use any known prediction algorithms to predict 302 the next n-word (which may include multiple predicted 302 words) that may be most likely to follow the current word recognized (e.g., via conversion from speech to text), given the partial result and the language model probabilities. For instance, prediction process 10 may analyze any portion of the email text previously/currently determined from the speech of user 50 (e.g., “I need to purchase my . . . ”). In the example, prediction process 10 may analyze this portion (and/or any other previous portions) of the email to predict 302 the next word(s) that user 50 is most likely to say. In the non-limiting example, the next n-word(s) 402 are predicted to be either “hotel room,” “flight,” or “train ticket.” Prediction process 10 may take as input one or more language models, ranging from general to use-case specific, which may effectively count how many times words appear in a specific sequence. Based on what user 50 has already entered (the partial result) or the ascribed intent or context of the partial result, the probability of what followed next may be calculated based on how many examples exist in the language model for each of the next word(s). So, in the example that user 50 said “I need to purchase my . . . ” the language model may have 700 examples of “flight,” 200 examples of “hotel room,” and 100 examples of “train,” so prediction process 10 may determine that there is a 70% chance (700/(700+200+100)) that an example of text relates to a flight, and then bias towards the various patterns of speech related to specifying a flight for the next n-words 402.

In some implementations, prediction process 10 may use other applications to help predict the next n-words. For example, prediction process 10 may access the location services and/or calendar application of user 50 to identify any information that could help predict the next n-words. For instance, if the location service (e.g., GPS) indicates that user 50 is currently in Boston, and the calendar application shows a meeting with Jsmith@emailaddress.com in Miami, prediction process 10 may predict that getting to the meeting may require accommodations (e.g., a hotel room) and/or travel accommodations (e.g., flight or train ticket, etc.).

In some implementations, prediction process 10 may present 304 in real time the next word that is predicted following the current word in the speech from the user. For instance, once prediction process 10 has predicted the next n-word(s) that may be most likely to follow the current word (e.g., “my”), the next n-words may be presented 304 to user 50 in multiple example ways. For example, in some implementations, presenting 304 to the user in real time the next word that is predicted following the current word in the speech may include displaying 310 the next word differently than another word in the speech that is not predicted. For instance, as shown in FIG. 4, the predicted next n-word(s) may be displayed 310 using a lighter font color than the non-predicted words. In some implementations, the predicted next n-word(s) (and/or phrases) may be displayed 310 using some sort of highlighting, bold, italics, underline, etc. In some implementations, prediction process 10 may also display hints (e.g., via object 404) describing how user 50 may directly accept any of the predicted next n-word(s) (e.g., snapping fingers, clapping hands, nodding, etc., as will be discussed further below).

In some implementations, presenting 304 to the user in real time the next word that is predicted following the current word in the speech may include playing 312 audio of the next word. For example, when the application and/or the computing device does not include or use a display (or even when a display is provided or used), prediction process 10 may play audio of the next n-word(s) using a speaker (e.g., a speaker of client electronic device 42). For instance, the predictions of the next n-word(s) may be “whispered” back to user 50 in rapid speech (e.g., faster than a normal speaking rate) using TTS. A “whisper” may generally be defined as speech that does not involve the vibration of the vocal cords, and it has less energy in lower frequency bands than ordinary speech. The whispered word may be played back quieter (lower decibel level) or more “softly spoken” than the current volume level setting would otherwise indicate.

In some implementations, prediction process 10 may receive 306 feedback from the user whether to one of accept and reject the next word that is predicted. For instance, prediction process 10 may receive 306 feedback from user 50 that may indicate whether or not user 50 would like to accept the predicted next n-word(s) (meaning the prediction was accurate) or reject the predicted next n-word(s) (meaning the prediction was inaccurate). In some implementations, receiving 306 feedback from the user may include receiving 316 a physical selection from the user of the next word on a device. For example, user 50 may physically select the predicted next n-word(s) by touching the them on a display, e.g., using a touch screen/button and/or mouse click, etc. As yet another example, user 50 may physically swipe on a smart watch or phone touch screen or shake the phone/smart watch to physically select the predicted next n-word(s). As yet another example, game controllers, TV remote controllers and similar devices may be used to receive the user feedback to accept/reject predictions. For instance, one button may be used to accept/reject the next predicted word while another button may accept/reject the whole predicted utterance. As another example, user 50 may speak into a TV remote controller “play” and prediction process 10 may predict “The Smiths Tale Series 2” (e.g., based on the user preference). User 50 may press the forward (or other) button a number of times (e.g., 4 times) to accept all the way up to and including “Series” and then say, e.g., “1” or press the play (or other) button to accept the whole string.

In some implementations, receiving 306 feedback from the user may include receiving 314 one of an audio input and a visual input from the user. For instance, as an audio input (e.g., received via a microphone), user 50 may speak the presented predicted next n-word(s), or make a pre-determined sound (e.g., clapping, snapping fingers, or a pre-determined word, such as “yes” or “first prediction”, etc.). In some implementations, the number of times user 50 claps or snaps (or makes any other pre-determined sound) may signify whether the predicted next n-word(s) is accepted or rejected. For example, two claps may indicate rejection and one clap may indicate acceptance. In some implementations, the audio input may be a lack of audio input (i.e., the user not pronouncing any of the predicted next n-word(s) to thereby ignore/reject them). In some implementations, user 50 may simply continue speaking, or may delay speaking by a pre-determined amount of time (e.g., 3 seconds) to ignore/reject predicted next n-word(s).

As another example, the visual input may include a physical gesture by the user captured by a device. For instance, as a visual input (e.g., received via a camera of client electronic device 42 or other sensor), user 50 may make a pre-determined hand gesture (e.g., thumbs up to accept or thumbs down to reject, head nodding up and down to accept or head shaking left to right to reject, or blinking while wearing smart glasses, etc.) while the predicted next n-word(s) are displayed/whispered. As another example, the visual input may be received via one or more sensors that may pick up gestures (e.g., infrared sensors or sensors worn when playing Virtual Reality (VR) games). It will be appreciated that any other visual gestures and/or devices may be used to accept/reject the predicted next n-word(s) without departing from the scope of the present disclosure.

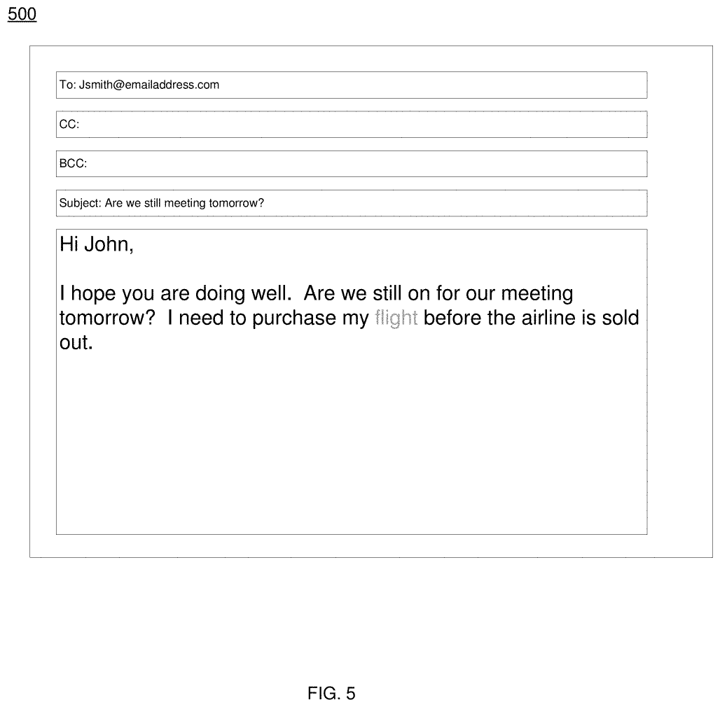

In some implementations, prediction process 10 may process 308 the speech from the user to convert the speech to text, wherein the text may include the next word when the feedback from the user is to accept the next word that is predicted and wherein the text may exclude the next word when the feedback from the user is to reject the next word that is predicted. For instance, an example and non-limiting user interface (e.g., UI 500) associated with prediction process 10 is shown in the example implementation of FIG. 5. In the example, assume that user 50 has accepted “flight” (one of the predicted next n-word(s)) using any of the above-noted example techniques. In the example, the speech from user 50 is processed 308 to convert the speech to text, and prediction process 10 may then include the accepted predicted next n-word(s) (e.g., “flight”) at the location in the speech/text where the prediction was previously displayed. In the example, the predicted next n-word(s) that has been accepted may still be indicated (e.g., via a different color font) or may be changed to the same font as the other text.

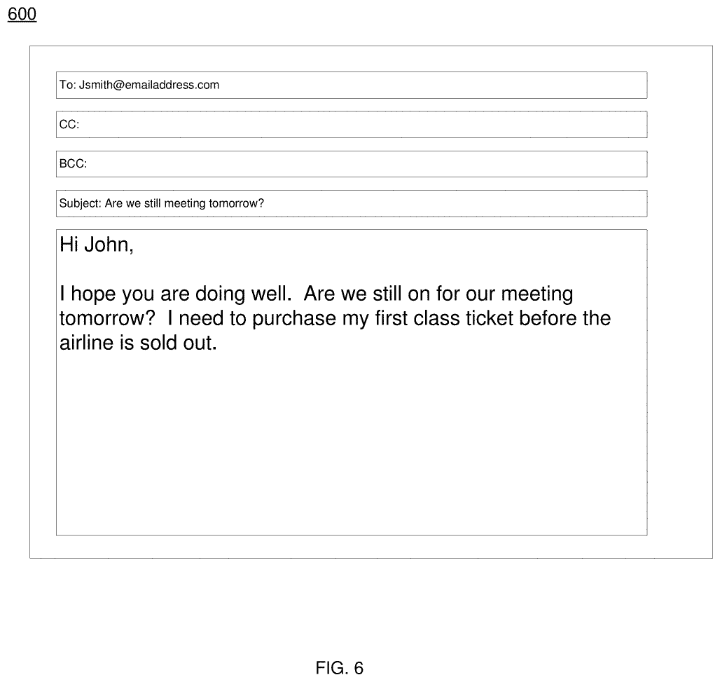

As another example, for instance, an example and non-limiting user interface (e.g., UI 600) associated with prediction process 10 is shown in the example implementation of FIG. 6. In the example, assume that user 50 has rejected all of the predicted next n-word(s) using any of the above-noted example techniques. In the example, the speech from user 50 is processed 308 to convert the speech to text, and prediction process 10 may then exclude the rejected predicted next n-word(s) at the location in the speech/text where the prediction was previously displayed. In the example, the rejected predicted next n-word(s) that has been rejected may be replaced with what user 50 has actually said (e.g., “first class ticket”) using any standard ASR technique.

It will be appreciated that while the examples include predicting the next n-word(s), the present disclosure may also predict the next n-phrases (e.g., “Thanks in advance,” “Please let me know as soon as possible,” etc.). As such, the use of predicting the next n-word(s) should be taken to include phrases, and should be taken as example only, but not to limit the scope of the present disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, by a computing device, speech from a user;
predicting a next word following a current word recognized in the speech from the user;
presenting to the user in real time the next word that is predicted following the current word in the speech from the user;
receiving feedback from the user whether to one of accept and reject the next word that is predicted; and
processing the speech from the user to convert the speech to text, wherein the text includes the next word when the feedback from the user is to accept the next word that is predicted and wherein the text excludes the next word when the feedback from the user is to reject the next word that is predicted.

2. The computer-implemented method of claim 1 wherein presenting to the user in real time the next word that is predicted following the current word in the speech includes displaying the next word differently than another word in the speech that is not predicted.

3. The computer-implemented method of claim 1 wherein presenting to the user in real time the next word that is predicted following the current word in the speech includes playing audio of the next word.

4. The computer-implemented method of claim 1 wherein receiving feedback from the user includes receiving one of an audio input and a visual input from the user.

5. The computer-implemented method of claim 4 wherein the audio input includes one of speech from the user pronouncing the next word, clapping, and snapping from the user.

6. The computer-implemented method of claim 4 wherein the visual input includes a physical gesture by the user captured by a device.

7. The computer-implemented method of claim 4 wherein receiving feedback from the user includes receiving a physical selection from the user of the next word on a device.

8. A computer program product residing on a computer readable storage medium having a plurality of instructions stored thereon which, when executed across one or more processors, causes at least a portion of the one or more processors to perform operations comprising:
receiving speech from a user;
predicting a next word following a current word recognized in the speech from the user;
presenting to the user in real time the next word that is predicted following the current word in the speech from the user;
receiving feedback from the user whether to one of accept and reject the next word that is predicted; and
processing the speech from the user to convert the speech to text, wherein the text includes the next word when the feedback from the user is to accept the next word that is predicted and wherein the text excludes the next word when the feedback from the user is to reject the next word that is predicted.

9. The computer program product of claim 8 wherein presenting to the user in real time the next word that is predicted following the current word in the speech includes displaying the next word differently than another word in the speech that is not predicted.

10. The computer program product of claim 8 wherein presenting to the user in real time the next word that is predicted following the current word in the speech includes playing audio of the next word.

11. The computer program product of claim 8 wherein receiving feedback from the user includes receiving one of an audio input and a visual input from the user.

12. The computer program product of claim 11 wherein the audio input includes one of speech from the user pronouncing the next word, clapping, and snapping from the user.

13. The computer program product of claim 11 wherein the visual input includes a physical gesture by the user captured by a device.

14. The computer program product of claim 11 wherein receiving feedback from the user includes receiving a physical selection from the user of the next word on a device.

15. A computing system including one or more processors and one or more memories configured to perform operations comprising:
receiving speech from a user;
predicting a next word following a current word recognized in the speech from the user;
presenting to the user in real time the next word that is predicted following the current word in the speech from the user;
receiving feedback from the user whether to one of accept and reject the next word that is predicted; and
processing the speech from the user to convert the speech to text, wherein the text includes the next word when the feedback from the user is to accept the next word that is predicted and wherein the text excludes the next word when the feedback from the user is to reject the next word that is predicted.

16. The computing system of claim 15 wherein presenting to the user in real time the next word that is predicted following the current word in the speech includes displaying the next word differently than another word in the speech that is not predicted.

17. The computing system of claim 15 wherein presenting to the user in real time the next word that is predicted following the current word in the speech includes playing audio of the next word.

18. The computing system of claim 15 wherein receiving feedback from the user includes receiving one of an audio input and a visual input from the user.

19. The computing system of claim 18 wherein the audio input includes one of speech from the user pronouncing the next word, clapping, and snapping from the user.

20. The computing system of claim 18 wherein the visual input includes a physical gesture by the user captured by a device.
